(19) United States
(12) Patent Application Publication
(10) Pub. No.: US 2026/0150003 A1
(43) Pub. Date: May 28, 2026

(54) SMALL DATA TRANSMISSION CONTROL

(71) Applicant: Nokia Technologies Oy, Espoo (FI)

(72) Inventors: Jussi-Pekka KOSKINEN, Oulu (FI); Samuli Heikki TURTINEN, Oulu (FI); Chunli WU, Beijing (CN)

(21) Appl. No.: 19/121,284

(22) PCT Filed: Nov. 3, 2022
(86) PCT No.: PCT/CN2022/129673

§ 371 Date: Apr. 15, 2025

(51) Int. Cl. H04W 28/06; H04W 76/19; H04W 76/20

(52) U.S. Cl. CPC H04W 28/06; H04W 76/19; H04W 76/20

(57) ABSTRACT

Example embodiments of the present disclosure are related to small data transmission control. A method comprising: receiving, by a terminal deice and from a network node, small data transmission, SDT, configuration information; determining, by the terminal device and based on the SDT configuration information, whether a mobile terminated, MT, SDT procedure and/or a mobile originated, MO, SDT procedure is allowed or not allowed to be used for the terminal device; and initiating or applying, by the terminal device, at least one of the MT SDT procedure or the MO SDT procedure based on the determination and/or the SDT configuration information.

### FIELDS

Various example embodiments of the present disclosure generally relate to the field of telecommunication and in particular, to methods, devices, apparatuses and computer readable storage medium for small data transmission control.

### BACKGROUND

In some communication systems, a terminal device can transition between an inactive state, an idle state, and a connected state. In the inactive state or the idle state, the terminal device may not have a connection established with a network node for communications. To avoid unnecessary signaling overhead and power consumption for establishing or reestablishing a connection, it has been agreed to support small data transmission (SDT) for a terminal device in the inactive state, without requiring the terminal device to establish a connection with a network node.

### SUMMARY

In a first aspect of the present disclosure, there is provided an apparatus. The apparatus comprises at least one processor; and at least one memory storing instructions that, when executed by the at least one processor, cause the apparatus at least to: receive, from a network node, small data transmission, SDT, configuration information; determine, based on the SDT configuration information, whether a mobile terminated, MT, SDT procedure and/or a mobile originated, MO, SDT procedure is allowed or not allowed to be used for the apparatus; and initiate or apply at least one of the MT SDT procedure or the MO SDT procedure based on the determination and/or the SDT configuration information.

In a second aspect of the present disclosure, there is provided an apparatus. The apparatus comprises at least one processor; and at least one memory storing instructions that, when executed by the at least one processor, cause the apparatus at least to: transmit to a terminal device, small data transmission, SDT, configuration information, wherein the SDT configuration information is to be used by the terminal device to determine a mobile terminated, MT, SDT procedure and/or a mobile originated, MO, SDT procedure is allowed or not allowed to be used for the terminal device; and perform or apply at least one of the MT SDT procedure or the MO SDT procedure with the terminal device based on the SDT configuration information.

In a third aspect of the present disclosure, there is provided a method. The method comprises: receiving, by a terminal device and from a network node, small data transmission, SDT, configuration information; determining, by the terminal device and based on the SDT configuration information, whether a mobile terminated, MT, SDT procedure and/or a mobile originated, MO, SDT procedure is allowed or not allowed to be used for the terminal device; and initiating or applying, by the terminal device, at least one of the MT SDT procedure or the MO SDT procedure based on the determination and/or the SDT configuration information.

In a fourth aspect of the present disclosure, there is provided a method. The method comprises: transmitting, by a network node and to a terminal device, small data transmission, SDT, configuration information, wherein the SDT configuration information is to be used by the terminal device to determine a mobile terminated, MT, SDT procedure and/or a mobile originated, MO, SDT procedure is allowed or not allowed to be used for the terminal device; and performing or applying, by the network node, at least one of the MT SDT procedure or the MO SDT procedure with the terminal device based on the SDT configuration information.

In a fifth aspect of the present disclosure, there is provided an apparatus. The apparatus comprises: means for receiving, from a network node, small data transmission, SDT, configuration information; means for determining, based on the SDT configuration information, whether a mobile terminated, MT, SDT procedure and/or a mobile originated, MO, SDT procedure is allowed or not allowed to be used for the apparatus; and means for initiating or applying at least one of the MT SDT procedure or the MO SDT procedure based on the determination and/or the SDT configuration information.

In a sixth aspect of the present disclosure, there is provided an apparatus. The apparatus comprises means for transmitting, to a terminal device, small data transmission, SDT, configuration information, wherein the SDT configuration information is to be used by the terminal device to determine a mobile terminated, MT, SDT procedure and/or a mobile originated, MO, SDT procedure is allowed or not allowed to be used for the terminal device; and means for performing or applying at least one of the MT SDT procedure or the MO SDT procedure with the terminal device based on the SDT configuration information.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3 illustrates a flowchart of a method implemented at a terminal device according to some example embodiments of the present disclosure;

FIG. 4 illustrates a flowchart of a method implemented at a network node according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” or “network node” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

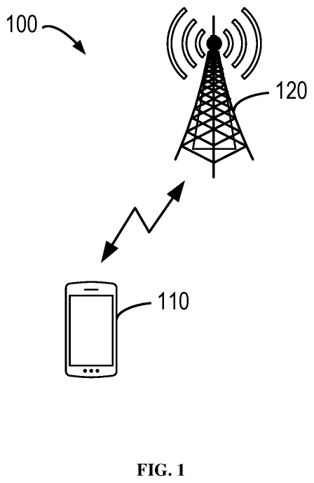

FIG. 1 illustrates an example communication environment 100 in which example embodiments of the present disclosure can be implemented. In the communication environment 100, a plurality of communication devices, including a terminal device 110 and a network node 120, can communicate with each other. The network node 120 is illustrated as a network node serving the terminal device 110. The serving area of the network node 120 may be called a cell.

In the following, for the purpose of illustration, some example embodiments are described with an apparatus operating as a terminal device 110 and a further apparatus operating as a network node 120. However, in some example embodiments, operations described in connection with a terminal device may be implemented at a network node or other device, and operations described in connection with a network node may be implemented at a terminal device or other device.

In some example embodiments, a link from the network node 120 to the terminal device 110 is referred to as a downlink (DL), while a link from the terminal device 110 to the network node 120 is referred to as an uplink (UL). In DL, the network node 120 is a transmitting (TX) device (or a transmitter) and the terminal device 110 is a receiving (RX) device (or a receiver). In UL, the terminal device 110 is a TX device (or a transmitter) and the network node 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located comprised in the communication environment 100.

In the communication environment 100, a communication device (e.g., a terminal device) can transition between an inactive state, an idle state, and a connected state. The inactive state may sometimes be referred to as an inactive mode, a Radio Resource Control (RRC) inactive (RRC_INACTIVE) state/mode, or an inactive state in a RRC_CONNECTED state/mode, and such terms are used interchangeably herein. The idle state may sometimes be referred to as an idle mode, a RRC idle (RRC_IDLE) state/mode, and such terms are used interchangeably herein. The connected state may sometimes be referred to as a connected mode, an active state/mode, or an RRC connected (RRC_CONNECTED) state/mode, and such terms are used interchangeably herein.

In the RRC inactive state or the RRC idle state, the terminal device has no connection established with the network node for data transmission and/or reception. In the connected state, a connection is established between the terminal device and the network node and thus the terminal device can perform normal data communication with the network node via the connection.

For the purpose of power saving and signaling overhead reduction, it is proposed to support small data transmission (SDT) for a terminal device in a non-RRC connected state. Currently it has been agreed that the terminal device in the RRC inactive state can perform SDT, without transitioning to the connected sate. It may be also support SDT for the terminal device in the RRC idle state. As used herein, the term “SDT” refers to a type of transmission where a small amount of data is triggered, although other terms may also be used. In some example embodiments, a SDT procedure may be initiated through a random access (RA) procedure and/or a configured grant (CG).

A SDT procedure may include a mobile originated (MO) SDT procedure, to allow small packet transmission for UL-oriented packets. For the MO SDT procedure, the terminal device may initiate a SDT procedure in case uplink data becomes available for transmission. The initiation of the SDT procedure may be performed based on certain SDT configuration.

It is further proposed to support a mobile terminated (MT) SDT procedure to allow DL-triggered small data transmission. MT SDT may achieve similar benefits of reducing signalling overhead and power consumption by not requiring the terminal device to transition to the RRC connected state and reducing latency by allowing fast transmission of small and infrequent packets, e.g. for positioning. In some example embodiments, a MT SDT procedure may be initiated if the terminal device is paged by the network node or if the terminal device is specifically paged to initiate a SDT procedure. For example, a MT SDT may be initiated if the terminal device in the RRC inactive state is paged with an Inactive-Radio Network Temporary Identity (I-RNTI).

In some example embodiments, for MO SDT, the terminal device may indicate the initiation of the SDT procedure by dedicated RACH resources that are configured by the network node. If there are no such RACH resources configured (for example, the SDT procedure is configured to use common RACH resources), the network node may deduce the need for SDT from a buffer status report (BSR) indicated by the terminal device in Message 3 (Msg3 ) in a RA procedure (if there is enough space in this message after the common control channel (CCCH) service data unit (SDU) and/or RRC Resume Request are included) or then after the successful contention resolution. This solution, on the other hand, affects similarly legacy terminal devices or other terminal devices not performing SDT procedures since the network needs to assign resources also for these terminal devices although they are not able to transmit data before the connection is established.

In some cases, a network node may want to use only MT SDT which may be fully under the control of the network node when specific DL data becomes available control whether SDT is needed or not. However, currently, the terminal device is allowed to initiate a MO SDT procedure in case related conditions are satisfied if SDT is enabled in the cell of the network node.

According to some example embodiments of the present disclosure, there is provided a solution for control of a SDT procedure. In this solution, SDT configuration information and/or transmission of such SDT configuration information from a network node to a terminal device can be controlled by the network node to decide whether a MT SDT procedure and/or a MO SDT procedure is allowed or not allowed to be used for the terminal device. The terminal device determines, based on the SDT configuration information, allowance of the MT SDT procedure and/or a MO SDT procedure and initiates or applies at least one of a MT SDT procedure or MO SDT procedure with the network node based on the determination and/or the SDT configuration information. Through this solution, the network node is able to control which SDT procedure(s) a terminal device can initiate and the configuration information used for the SDT procedure(s) to be initiated. This increase the control flexibility by the network node with respect to terminal devices in the cell.

Example embodiments of the present disclosure will be described in detail below with reference to the accompanying drawings.

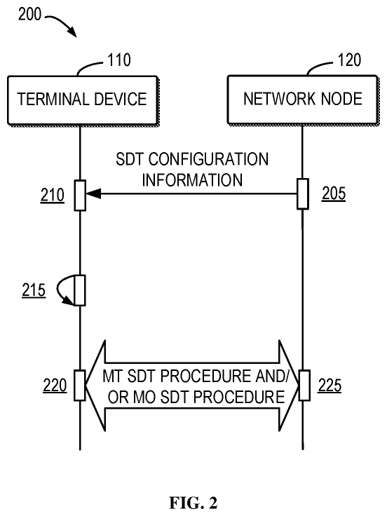

Reference is now made to FIG. 2, which shows a signaling chart 200 for communication according to some example embodiments of the present disclosure. For the purpose of discussion, reference is made to FIG. 1 to describe the signaling chart 200. As shown in FIG. 2, the signaling chart 200 involves a terminal device 110 and a network node 120.

In the signaling chart 200, the network node 120 transmits 205, to the terminal device 110, SDT configuration information. The terminal device 110 receives 210, from a network node 110, small data transmission, SDT, configuration information. The terminal device 110 determines 215, based on the received SDT configuration information, whether a MT SDT procedure and/or a MO SDT procedure is allowed or not allowed to be used for the terminal device 110. In some example embodiments, the network node 120 may control specific information contained in the SDT configuration information and/or the transmission of the SDT configuration information, to control whether and/or how a MT SDT procedure and/or a MO SDT procedure is allowed to be used for the terminal device 110. According to at least the received SDT configuration information, the terminal device 110 may be able to determine allowance of the MT SDT procedure and/or the MO SDT procedure.

A SDT procedure may include a MT SDT procedure and a MO SDT procedure. A MT SDT procedure refers to a SDT procedure triggered by a network node for data transmission in DL. A MO SDT procedure refers to a SDT procedure triggered by a terminal device for data transmission in UL.

In some example embodiments, a MT SDT procedure also refers to a MO SDT procedure triggered by a network node for data transmission in DL. In this case, paging for SDT triggers the terminal device to perform a MO SDT procedure and DL data can be transmitted during that procedure.

SDT may be allowed for a terminal device in a non-RRC connected state. In some example embodiments, if the terminal device 110 is in the RRC inactive state, it may initiate SDT with the network node 120. In some example embodiments, if the terminal device 110 is in the RRC idle state, it may initiate SDT with the network node 120. In example embodiments of the present disclosure, the terminal device 110 initiates or applies 220 at least one of the MT SDT procedure or the MO SDT procedure based on the determination of whether the MT SDT procedure and/or a MO SDT procedure is allowed or not and/or based on the received SDT configuration information. The network node 120 performs or applies 225 at least one of the MT SDT procedure or the MO SDT procedure with the terminal device 110 based on the SDT configuration information.

In some example embodiments, if the MO SDT procedure is not allowed, the terminal device 110 may be allowed only to use the received SDT configuration information for a MT SDT procedure. In this case, the terminal device 110 may apply the SDT configuration information only to the MT SDT procedure. The terminal device 110 may initiate or apply only the MT SDT procedure with the network node 120 based on the SDT configuration information.

In some example embodiments, the network node 120 may signal via dedicated signaling and/or broadcast signaling whether a MO SDT procedure is allowed in case the terminal device 110 is configured with the SDT configuration information.

In some example embodiments, the SDT configuration information may be indicative of whether the MT SDT procedure and/or the MO SDT procedure is allowed or not allowed to be used for the terminal device 110. Thus, the terminal device 110 may determine, from the SDT configuration information, the allowance of whether the MT SDT procedure and/or the MO SDT procedure. In some example embodiments, the SDT configuration information indicates explicitly whether the MT SDT procedure and/or the MO SDT procedure is allowed or not allowed to be used for the terminal device 110.

In some example embodiments, the SDT configuration information from the network node 120 to the terminal device 110 may comprise at least one of a MO SDT configuration for the MO SDT procedure or a MT SDT configuration for the MT SDT procedure. That is, the MT SDT configuration may be defined as a separate configuration from the MO SDT configuration. If both of the MT SDT configuration and the MO SDT configuration are transmitted from the network node 120, the MO SDT configuration may be separate or different from the MT SDT configuration.

In some cases, if the network node 120 determines to configure the terminal device 110 with the MT SDT configuration but not with the MO SDT configuration, the terminal device 110 may determine that the MT SDT procedure is allowed but the MO SDT procedure is not allowed. In those cases, the terminal device 110 may initiate or apply only the MT SDT procedure for data communication between the terminal device 110 and the network node 120. The initiation or applying of the MT SDT procedure may be based on the SDT configuration information (for example, the MT SDT configuration comprised in the SDT configuration information).

In some cases, if the network node 120 determines to configure the terminal device 110 with the MO SDT configuration but not with the MT SDT configuration, the terminal device 110 may determine that the MO SDT procedure is allowed but the MT SDT procedure is not allowed. In those cases, the terminal device 110 may initiate or apply only the MO SDT procedure for data communication between the terminal device 110 and the network node 120. The initiation or applying of the MO SDT procedure may be based on the SDT configuration information (for example, the MO SDT configuration comprised in the SDT configuration information).

In some further cases, if the network node 120 determines to configure the terminal device 110 with both the MT SDT configuration and the MO SDT configuration, the terminal device 110 may determine that both the MT SDT procedure and the MO SDT procedure are allowed. The terminal device 110 may initiate or apply the MT SDT procedure and/or the MO SDT procedure for data communication as needed based on the SDT configuration information (for example, the MT SDT configuration and/or the MO SDT configuration in the SDT configuration information).

In some example embodiments, a configuration for a SDT procedure (e.g., a MO SDT configuration for the MO SDT procedure or a MT SDT configuration for the MT SDT procedure) indicate one or more configuration parameters related to the corresponding SDT procedure. In some example embodiments, a MT SDT configuration for the MT SDT procedure may indicate a resource configuration specific for the MT SDT procedure. The resource configuration may indicate one or more resources, e.g., RACH resources and/or CG, to be used by the MT SDT procedure. The resources RACH resources for the MT SDT procedure may comprise legacy SDT RACH resources, MT SDT RACH resources, and/or common RACH resources.

In some example embodiments, a MO SDT configuration for the MO SDT procedure may indicate a resource configuration specific for the MO SDT procedure. The resource configuration may indicate one or more resources, e.g., RACH resources and/or CG, to be used by the MO SDT procedure. The resources RACH resources for the MO SDT procedure may comprise legacy SDT RACH resources, MO SDT RACH resources, and/or common RACH resources. Alternatively or in addition, either one of the MT SDT configuration and the MO SDT configuration may indicate one or more related conditions for triggering the corresponding SDT procedure.

For MO SDT, a terminal device may determine whether it can trigger a MO SDT procedure based on a determination of whether the related conditions are satisfied. In some examples, the satisfaction of the related condition(s) may be based on one or more of the following: a UL data volume threshold, a radio condition, data belongs to a radio bearer(s) configured for SDT, a timer value (e.g., a t319a timer value), and the like. The radio condition may be measured based on a reference signal received power (RSRP) of a communication link between the terminal device 110 and the network node 120. The radio condition may indicate that a SDT procedure may be initiated if the RSRP is a RSRP threshold configured in the SDT configuration information. The RSRP threshold is used to evaluate whether the terminal device can initiate a RRC Resume procedure even though the network node 120 indicates in a paging message that there is DL data available. This is to ensure successful transmission of the DL data in case the terminal device is in worse channel conditions than the RSRP threshold allows.

For the MO SDT, the terminal device 110 may initiate a MO SDT procedure if a UL data volume available for transmission exceeds the UL data volume threshold. For example, if a data volume of pending UL data across all resource bearers (RBs) configured for SDT is less than or equal to the UL data volume threshold. In some cases, for a SDT procedure, the terminal device 110 may also consider the suspended RBs configured with SDT for data volume calculation. Alternatively, or in addition, the terminal device 110 may initiate a MO SDT procedure if the RSRP of a reference signal (e.g., a DL pathloss reference signal) is higher than a RSRP threshold.

The MT SDT configuration may be determined as the same as or different from the MO SDT configuration. It may be up to the network node 120 to define whether the resources and/or related conditions for triggering a MT SDT procedure and a MO SDT procedure can be the same or be different from each other.

In some examples, for MT SDT, the related RSRP threshold may be used to determine whether the terminal device 110 can initiate a normal Resume procedure even though the network node 120 indicates in a paging message that there is DL SDT available. This is to ensure successful transmission of DL data in case the terminal device 110 is in worse channel conditions than the RSRP threshold allows.

On the other hand, for MT-SDT, the terminal device 110 may or may not have any UL SDT data to be transmitted. In this case, it would be useless to use the SDT specific RACH resources (if configured) in case the terminal device 110 does not have any SDT UL data to transmit since the network node 120 would likely allocate a bigger amount of resources for transmission (e.g., Msg3 transmission) so as to fit at least part of the UL SDT data into it. In this case, it may be beneficial to allow the terminal device 110 configured with MT SDT access to use normal RACH resources to initiate a SDT Resume procedure with the network node, which may avoid unuse of resources in case no UL SDT data is available. By allowing the network node to separately configure the resources for the MT SDT procedure and the MO SDT procedure according to some embodiments of the present disclosure, the resource usage can be further improved.

In some example embodiments, the SDT configuration information may comprise a SDT configuration used as the MO SDT configuration and the MT SDT configuration, respectively. That is, the MT SDT configuration and MO SDT configuration may be indicated as the same SDT configuration. This SDT configuration may indicate one or more configuration parameters related to a SDT procedure.

In some example embodiments, if a same SDT configuration is comprised in the SDT configuration information, the network node 120 may explicitly indicate whether the SDT configuration can be used for a MT SDT procedure or a MO SDT procedure or both. By receiving, from the network node 120, an indication indicating whether the SDT configuration is to be used for the MT SDT procedure and/or the MO SDT procedure, the terminal device 110 may be able to determine whether the MT SDT procedure and/or the MO SDT procedure is allowed to be used for the terminal device 110 based on the received SDT configuration information.

In some example embodiments, if a same SDT configuration is comprised in the SDT configuration information, the terminal device 110 may be allowed by default to use the SDT configuration for both a MT SDT procedure and a MO SDT procedure. Accordingly, the terminal device 110 in the RRC inactive state or in the RRC idle state may initiate or apply the MT SDT procedure and the MO SDT procedure respectively based on the SDT configuration.

In some example embodiments, the network node 120 may transmit the SDT configuration information via dedicated signaling. In some example embodiments, the dedicated signaling may be, for example, a RRC Release message, although other signaling may also be applicable. In some example embodiments, the network node 120 may configured the terminal device 110 via dedicated signaling with a timer value (e.g., a t319a timer value) and/or a RSRP threshold for SDT initiation to be used for MO SDT in cells that do not provide a SDT configuration over system information (SI). In some example embodiments, alternatively or in addition, the network node 120 may transmit the SDT configuration information via common signaling.

In some example embodiments, if the network node 120 transmits the SDT configuration information over the dedicated signaling or the specific common signaling to the terminal device 110, the terminal device 110 may determine, based on such reception of the SDT configuration information, that only the MT SDT procedure is allowed. In some example embodiments, if the network node 120 transmits the SDT configuration information over the dedicated signaling to the terminal device 110, the terminal device 110 may use the dedicatedly configured information regardless of SDT configuration being broadcasted in a cell. For example, the terminal device 110 may initiate or apply only the MT SDT procedure based on the SDT configuration information regardless of other SDT configuration information received via broadcasted signaling.

In some example embodiments, the SDT configuration information may comprise a specific UL data volume threshold for initiating or triggering a MO SDT procedure. In some example embodiments, the network node 120 may transmit this special UL data volume threshold to determine that the MO SDT procedure is not allowed. In some example embodiments, the network node 120 may transmit this special UL data volume threshold to determine that the MO SDT procedure is allowed. For example, a UL data volume threshold that can be actually used for initiating or triggering a MO SDT procedure may indicate one or more non-zero bytes. The non-zero bytes for the UL data volume threshold may be, for example, one or more of 32 bytes, 100 bytes, 200 byte, 400 byte, 600 bytes, 800 bytes, 1000 bytes, 2000 byte, 4000 bytes, 8000 bytes, 9000 bytes, 10000 bytes, 12000 bytes, 24000 bytes, 48000 bytes, 96000 bytes. A new value “zero byte” may be introduced as the specific UL data volume threshold to indicate that the SDT configuration information is only intended for a MT SDT procedure and is disallowed for a MO SDT procedure. Currently, when SDT is configured for the terminal device 110, the UL data volume threshold is mandatory configured with a minimum value of 32 byte. By introducing the new value, it is possible to indicate the allowance of the MT SDT procedure and/or the MO SDT procedure using the existing field (e.g., sdt-DataVolumeThreshold).

In some example embodiments, a SDT procedure may be triggered in case UL data may become available for transmission by the terminal device 110. Alternatively, or in addition, a SDT procedure may be triggered in case the network node 120 pages the terminal device 110. Alternatively, or in addition, a SDT procedure may be triggered in case the network node 120 pages the terminal device 110 to initiate the SDT procedure.

In some example embodiments, to initiate a SDT procedure, the terminal device 110 may determine whether to initiate a RRC Resume procedure or a MO SDT procedure in case UL data may become available for transmission. The terminal device 110 may further determine which resources (e.g., RACH resources) are to be used for initiating the SDT procedure. Based on the determination, the terminal device 110 may initiate the RRC Resume procedure or the MO SDT procedure using the determined resources.

In some example embodiments, the terminal device 110 may initiate a non-SDT RRC Resume procedure in case the MO SDT procedure and/or the MT SDT procedure is not allowed.

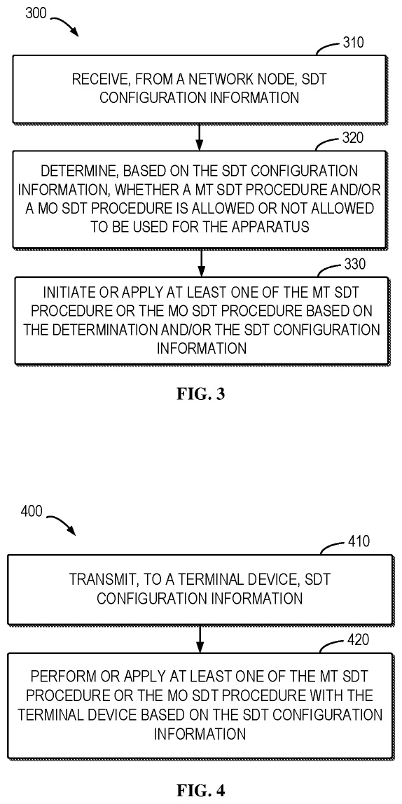

FIG. 3 illustrates a flowchart of a method 300 implemented at a terminal device according to some example embodiments of the present disclosure. For the purpose of discussion, the method 300 will be described from the perspective of the terminal device 110 in FIG. 1.

At block 310, the terminal device 110 receives, from a network node 120, SDT configuration information.

At block 320, the terminal device 110 determines, based on the SDT configuration information, whether a MT SDT procedure and/or a MO SDT procedure is allowed or not allowed to be used for the terminal device 110.

At block 330, the terminal device 110 initiates or applies, at least one of the MT SDT procedure or the MO SDT procedure based on the determination and the SDT configuration information. In some example embodiments, the terminal device 110 is in a Radio Resource Control, RRC, inactive state. In some example embodiments, the terminal device 110 is in a Radio Resource Control, RRC, idle state.

In some example embodiments, the SDT configuration information is indicative of whether the MT SDT procedure and/or the MO SDT procedure is allowed or not allowed to be used for the terminal device 110.

In some example embodiments, and in case the MO SDT procedure is not allowed, the terminal device 110 may apply the SDT configuration information only to the MT SDT procedure.

In some example embodiments, the SDT configuration information comprises at least one of a MO SDT configuration for the MO SDT procedure or a MT SDT configuration for the MT SDT procedure.

In some example embodiments, the MO SDT configuration is separate or different from the MT SDT configuration.

In some example embodiments, the terminal device 110 may initiate or apply only the MT SDT procedure for data communication between the terminal device 110 and the network node 120 in case the terminal device 110 is configured with the MT SDT configuration but not configured with the MO SDT configuration.

In some example embodiments, the SDT configuration information comprises a SDT configuration used as the MO SDT configuration and the MT SDT configuration, respectively.

In some example embodiments, the terminal device 110 may further receive, from the network node 120, an indication indicating whether the SDT configuration is to be used for the MT SDT procedure and/or the MO SDT procedure.

In some example embodiments, the terminal device 110 may initiate or apply the SDT configuration for the MT SDT procedure and the MO SDT procedure respectively.

In some example embodiments, the terminal device 110 may further receive, from the network node 120, the SDT configuration information via dedicated signaling or common signaling.

In some example embodiments, the terminal device 110 may initiate only the MT SDT procedure based on the SDT configuration information regardless of other SDT configuration information received via broadcasted signaling.

In some example embodiments, the SDT configuration information comprises a resource configuration specific for the MT SDT procedure.

In some example embodiments, the SDT configuration information comprises a specific uplink data volume threshold for initiating or triggering the MO SDT procedure. In some example embodiments, the terminal device 110 may further determine, based on the specific uplink data volume threshold, that the MO SDT procedure is not allowed.

In some example embodiments, the SDT procedure is initiated in case at least one of the following: uplink data becomes available for transmission by the terminal device 110, the network node 120 pages the terminal device 110, or the network node 120 pages the terminal device 110 to initiate the SDT procedure.

In some example embodiments, a non-SDT RRC Resume procedure is initiated in case the MO SDT procedure and/or the MT SDT procedure is not allowed.

FIG. 4 illustrates a flowchart of a method 400 implemented at a network node according to some example embodiments of the present disclosure. For the purpose of discussion, the method 400 will be described from the perspective of the network node 120 in FIG. 1.

At block 410, the network node 120 transmits, to a terminal device 110, SDT configuration information. The SDT configuration information is to be used by the terminal device to determine a mobile terminated, MT, SDT procedure and/or a mobile originated, MO, SDT procedure is allowed or not allowed to be used for the terminal device.

At block 420, the network node 120 performs or applies at least one of the MT SDT procedure or the MO SDT procedure with the terminal device based on the SDT configuration information. In some example embodiments, the terminal device 110 is in a Radio Resource Control, RRC, inactive state. In some example embodiments, the terminal device 110 is in a Radio Resource Control, RRC, idle state.

In some example embodiments, the SDT configuration information is indicative of whether the MT SDT procedure and/or the MO SDT procedure is allowed or not allowed to be used for the terminal device.

In some example embodiments, the SDT configuration information comprises at least one of a MO SDT configuration for the MO SDT procedure or a MT SDT configuration for the MT SDT procedure.

In some example embodiments, the MO SDT configuration is separate or different from the MT SDT configuration.

In some example embodiments, the SDT configuration information comprises a SDT configuration used as the MO SDT configuration and the MT SDT configuration, respectively.

In some example embodiments, the network node 120 may further transmit, to the terminal device 110, an indication indicating whether the SDT configuration is to be used for the MT SDT procedure and/or the MO SDT procedure.

In some example embodiments, the network node 120 may transmit, to the terminal device, the SDT configuration information via dedicated signaling or common signaling, the SDT configuration information to be used only for the MT SDT procedure.

In some example embodiments, the SDT configuration information comprises a resource configuration specific for the MT SDT procedure.

In some example embodiments, the SDT configuration information comprises a specific uplink data volume threshold for initiating a MO SDT procedure, the specific threshold being used to indicate to the terminal device 110 that the MO SDT procedure is allowed or not allowed.

In some example embodiments, an apparatus capable of performing any of the method 300 (for example, the terminal device 110 in FIG. 1 may comprise means for performing the respective operations of the method 300. The means may be implemented in any suitable form. For example, the means may be implemented in a circuitry or software module. The apparatus may be implemented as or included in the terminal device 110 in FIG. 1

In some example embodiments, the apparatus comprises means for receiving, from a network node, small data transmission, SDT, configuration information; means for determining, based on the SDT configuration information, whether a mobile terminated, MT, SDT procedure and/or a mobile originated, MO, SDT procedure is allowed or not allowed to be used for the apparatus; and means for initiating or applying at least one of the MT SDT procedure or the MO SDT procedure based on the determination and/or the SDT configuration information.

In some example embodiments, the apparatus is in a Radio Resource Control, RRC, inactive state. In some example embodiments, the apparatus is in a Radio Resource Control, RRC, idle state.

In some example embodiments, the SDT configuration information is indicative of whether the MT SDT procedure and/or the MO SDT procedure is allowed or not allowed to be used for the apparatus.

In some example embodiments, the means for initiating comprises: means for applying, in case the MO SDT procedure is not allowed, the SDT configuration information only to the MT SDT procedure.

In some example embodiments, the SDT configuration information comprises at least one of a MO SDT configuration for the MO SDT procedure or a MT SDT configuration for the MT SDT procedure.

In some example embodiments, the MO SDT configuration is separate or different from the MT SDT configuration.

In some example embodiments, the means for initiating comprises: means for initiating or applying only the MT SDT procedure for data communication between the apparatus and the network node in case the apparatus is configured with the MT SDT configuration but not configured with the MO SDT configuration.

In some example embodiments, the SDT configuration information comprises a SDT configuration used as the MO SDT configuration and the MT SDT configuration, respectively.

In some example embodiments, the apparatus further comprises: means for receiving, from the network node, an indication indicating whether the SDT configuration is to be used for the MT SDT procedure and/or the MO SDT procedure.

In some example embodiments, the means for initiating comprises: means for initiating or applying the MT SDT procedure and the MO SDT procedure respectively based on the SDT configuration.

In some example embodiments, the apparatus further comprises: means for receiving, from the network node, the SDT configuration information via dedicated signaling or common signaling.

In some example embodiments, the means for initiating comprises: means for initiating or applying only the MT SDT procedure based on the SDT configuration information regardless of other SDT configuration information received via broadcasted signaling.

In some example embodiments, the SDT configuration information comprises a resource configuration specific for the MT SDT procedure.

In some example embodiments, the SDT configuration information comprises a specific uplink data volume threshold for initiating or triggering the MO SDT procedure, and wherein the apparatus is further caused to perform: means for determining, based on the specific uplink data volume threshold, that the MO SDT procedure is allowed or not allowed.

In some example embodiments, the SDT procedure is initiated in case at least one of the following: uplink data becomes available for transmission by the apparatus, the network node pages the apparatus, or the network node pages the apparatus to initiate the SDT procedure.

In some example embodiments, a non-SDT RRC Resume procedure is initiated in case the MO SDT procedure and/or the MT SDT procedure is not allowed.

In some example embodiments, the apparatus further comprises means for performing other operations in some example embodiments of the method 300 or the terminal device 110. In some example embodiments, the means comprises at least one processor; and at least one memory storing instructions that, when executed by the at least one processor, cause the performance of the apparatus.

In some example embodiments, an apparatus capable of performing any of the method 400 (for example, the network node 120 in FIG. 1) may comprise means for performing the respective operations of the method 400. The means may be implemented in any suitable form. For example, the means may be implemented in a circuitry or software module. The apparatus may be implemented as or included in the network node 120 in FIG. 1

In some example embodiments, the apparatus comprises means for transmitting, to a terminal device, small data transmission, SDT, configuration information, wherein the SDT configuration information is to be used by the terminal device to determine a mobile terminated, MT, SDT procedure and/or a mobile originated, MO, SDT procedure is allowed or not allowed to be used for the terminal device; and means for performing or applying at least one of the MT SDT procedure or the MO SDT procedure with the terminal device based on the SDT configuration information.

In some example embodiments, the terminal device is in a Radio Resource Control, RRC, inactive state. In some example embodiments, the terminal device is in a Radio Resource Control, RRC, idle state.

In some example embodiments, the SDT configuration information is indicative of whether the MT SDT procedure and/or the MO SDT procedure is allowed or not allowed to be used for the terminal device.

In some example embodiments, the SDT configuration information comprises at least one of a MO SDT configuration for the MO SDT procedure or a MT SDT configuration for the MT SDT procedure.

In some example embodiments, the MO SDT configuration is separate or different from the MT SDT configuration.

In some example embodiments, the SDT configuration information comprises a SDT configuration used as the MO SDT configuration and the MT SDT configuration, respectively.

In some example embodiments, the apparatus further comprises: means for transmitting, to the terminal device, an indication indicating whether the SDT configuration is to be used for the MT SDT procedure and/or the MO SDT procedure.

In some example embodiments, the apparatus further comprises: means for transmitting, to the terminal device, the SDT configuration information via dedicated signaling or common signaling, the SDT configuration information to be used only for the MT SDT procedure.

In some example embodiments, the SDT configuration information comprises a resource configuration specific for the MT SDT procedure.

In some example embodiments, the SDT configuration information comprises a specific uplink data volume threshold for initiating a MO SDT procedure, the specific threshold being used to indicate to the terminal device that the MO SDT procedure is allowed or not allowed.

In some example embodiments, the apparatus further comprises means for performing other operations in some example embodiments of the method 400 or the network node 120. In some example embodiments, the means comprises at least one processor; and at least one memory storing instructions that, when executed by the at least one processor, cause the performance of the apparatus.

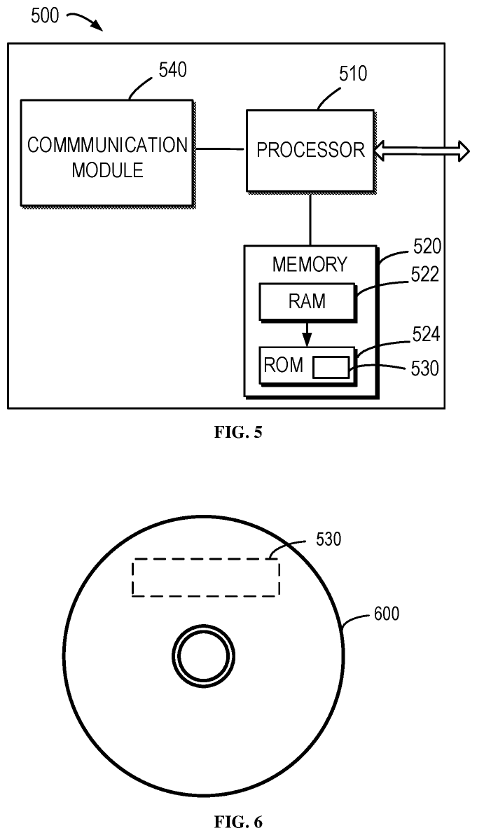

FIG. 5 is a simplified block diagram of a device 500 that is suitable for implementing example embodiments of the present disclosure. The device 500 may be provided to implement a communication device, for example, the terminal device 110 or the network node 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. An apparatus comprising:
at least one processor; and
at least one memory storing instructions that, when executed by the at least one processor, cause the apparatus at least to:
receive, from a network node, small data transmission (SDT) configuration information;
determine, based on the SDT configuration information, at least one of: whether a mobile terminated (MT) SDT procedure is allowed or not allowed to be used for the apparatus or whether a mobile originated (MO) SDT procedure is allowed or not allowed to be used for the apparatus; and
initiate or apply at least one of the MT SDT procedure or the MO SDT procedure based at least in part on the determination.

35. The apparatus of claim 34, wherein the apparatus is in a Radio Resource Control (RRC) inactive state or an RRC idle state.

36. The apparatus of claim 34, wherein the SDT configuration information is indicative of whether at least one of the MT SDT procedure or the MO SDT procedure is allowed or not allowed to be used for the apparatus.

37. The apparatus of claim 34, wherein the apparatus is caused to:
in case the MO SDT procedure is not allowed, apply the SDT configuration information only to the MT SDT procedure.

38. The apparatus of claim 34, wherein the SDT configuration information comprises at least one of a MO SDT configuration for the MO SDT procedure or a MT SDT configuration for the MT SDT procedure.

39. The apparatus of claim 38, wherein the MO SDT configuration is separate or different from the MT SDT configuration.

40. The apparatus of claim 38, wherein the apparatus is caused to:
initiate or apply the MT SDT procedure, but not the MO SDT procedure, for data communication between the apparatus and the network node in case the apparatus is configured with the MT SDT configuration but not configured with the MO SDT configuration.

41. The apparatus of claim 38, wherein the SDT configuration information comprises a SDT configuration used as the MO SDT configuration and the MT SDT configuration, respectively.

42. The apparatus of claim 41, wherein the apparatus is further caused to:
receive, from the network node, an indication indicating whether the SDT configuration is to be used for at least one of the MT SDT procedure or the MO SDT procedure.

43. The apparatus of claim 34, wherein the apparatus is caused to:
receive, from the network node, the SDT configuration information via dedicated signaling or common signaling.

44. The apparatus of claim 34, wherein the SDT configuration information comprises a resource configuration specific for the MT SDT procedure.

45. The apparatus of claim 34, wherein the SDT configuration information comprises a specific uplink data volume threshold for initiating or triggering the MO SDT procedure, and wherein the apparatus is further caused to:
determine, based on the specific uplink data volume threshold, that the MO SDT procedure is allowed or not allowed.

46. The apparatus of claim 34, wherein the at least one of the MT SDT procedure or the MO SDT procedure is initiated in case at least one of the following:
uplink data becomes available for transmission by the apparatus in a RRC inactive state;
the network node pages the apparatus in the RRC inactive state; or
the network node pages the apparatus in the RRC inactive state to initiate a SDT procedure.

47. The apparatus of claim 34, wherein the apparatus is further caused to:
initiate a non-SDT RRC Resume procedure in case at least one of the MO SDT procedure or the MT SDT procedure is not allowed.

48. An apparatus comprising:
at least one processor; and
at least one memory storing instructions that, when executed by the at least one processor, cause the apparatus at least to:
transmit, to a terminal device, small data transmission (SDT) configuration information, indicating at least one of: whether a mobile terminated (MT) SDT procedure is allowed or not allowed to be used for the terminal device or whether a mobile originated (MO) SDT procedure is allowed or not allowed to be used for the terminal device; and
perform or apply at least one of the MT SDT procedure or the MO SDT procedure with the terminal device in accordance with the SDT configuration information.

49. The apparatus of claim 48, wherein the SDT configuration information comprises at least one of a MO SDT configuration for the MO SDT procedure or a MT SDT configuration for the MT SDT procedure.

50. The apparatus of claim 48, wherein the apparatus is caused to:
transmit, to the terminal device, the SDT configuration information via dedicated signaling or common signaling.

51. The apparatus of claim 48, wherein the SDT configuration information comprises a resource configuration specific for the MT SDT procedure.

52. The apparatus of claim 48 wherein the SDT configuration information comprises a specific uplink data volume threshold for initiating a MO SDT procedure, the specific threshold being used to indicate to the terminal device that the MO SDT procedure is allowed or not allowed.

53. A method comprising:
receiving, by a terminal device and from a network node, small data transmission, SDT, configuration information;
determining, by the terminal device and based on the SDT configuration information, at least one of: whether a mobile terminated (MT) SDT procedure is allowed or not allowed to be used for the terminal device or whether a mobile originated (MO) SDT procedure is allowed or not allowed to be used for the terminal device; and
initiating or applying, by the terminal device, at least one of the MT SDT procedure or the MO SDT procedure based at least in part on the determination.
